(19) United States
(12) Patent Application Publication
(10) Pub. No.: US 2006/0207578 A1
(43) Pub. Date: Sep. 21, 2006

(54) Multifunctional module, motor vehicle comprising such a module and process for manufacturing such a module

(75) Inventors: Marco Gallino, Torino (IT); Anthony Alves, Strasbourg (FR); Jacques Vetois, Duttlenheim (FR)

Correspondence Address: GREENBLUM & BERNSTEIN, P.L.C., 1950 ROLAND CLARKE PLACE, RESTON, VA, 20191, US

(73) Assignee: MARK IV SYSTEMES MOTEURS (SAS), Courbevoie (FR)

(21) Appl. No.: 11/228,287

(22) Filed: Sep. 19, 2005

(30) Foreign Application Priority Data
Sep. 20, 2004 (FR) 0409923

(51) Int. Cl. F02M 25/07

(52) U.S. Cl. 123/568.12

(57) ABSTRACT

A multifunctional module for internal combustion engine, forming a structural assembly and incorporating the functions of exhaust gas cooling and regulation, at least in part, of the circulation flows in said engine's cooling circuit, comprising a first functional unit incorporating, on the one hand, a part at least of an exhaust gas recirculation circuit and a heat exchanger for cooling the gases, preferably of elongated form, together with at least one gas flow regulation/diversion component, and, on the other hand, a part at least of the engine cooling circuit, with at least the water outlet casing and a thermostatic component for regulating the flow therein; the structural assembly comprises a second functional unit in the form of a substantially flat, plate-shaped body, consisting of a stiffening and fixing plate for the first functional unit and a thermal isolation interface between the first functional unit and the engine block; the plate-shaped body comprises on one of its faces sites for fitting and fixing the first functional unit and on the other face sites for fitting and fixing on the engine block.

The present invention relates to the field of motor vehicle parts and accessories, more particularly peripheral or secondary systems for the internal combustion engines of such vehicles, and relates to a multifunctional module, a motor vehicle comprising such a module and a process for manufacturing such a module.

### BACKGROUND OF THE INVENTION

At present, the space available under the engine bonnet of vehicles is ever more restricted, particularly around the engine block, and tends to favour integration of the functions to be carried out with a view to reducing size, while maintaining their quality and performance longevity, on which the vehicle's operational reliability depends.

In addition, in terms of developing and manufacturing internal combustion engine vehicles, the current trend is no longer to think in terms of isolated elements, namely components or parts, but in terms of assemblies, units or modules, each fulfilling an overall function or several interdependent functions.

This is particularly the case for functions connected simultaneously to the engine cooling circuit and the recirculation or reinjection of exhaust gases (EGR).

It would of course be advantageous, for reasons of compactness and size reduction, as well as for reasons of reducing the number of parts and assembly and fitting operations, to integrate, for example, at least some of the functions of regulation and distribution of the coolant liquid when it leaves the engine block with the cooling function of the gases to be recycled, to achieve a single structural unit fulfilling these various functions.

In addition, if such a unit could also incorporate conduit portions of the respective circulation circuits, it would be possible to reduce still further the number of separate parts needed, as well as the length of the corresponding circuits, allowing, for example, rapid warming of the engine to be achieved after a cold start.

Moreover, to achieve a compact installation that does not require a particular support structure to retain it under the vehicle's bonnet, it would be useful to fix such a unit directly on the engine block.

Finally, it is also advantageous, for economic reasons, to produce at least certain constituent parts of such a unit in a plastics material, which must however be protected against too high temperatures.

### SUMMARY OF THE INVENTION

The object of the present invention is to meet at least some of the expectations stated above, some of which are contradictory in terms of requirements.

Accordingly, the main object of the present invention is a multifunctional module is for internal combustion engines, forming a structural assembly and incorporating the functions of exhaust gas cooling and the at least partial regulation of circulation flows in the cooling circuit of said engine, a module characterized in that said structural assembly comprises a first functional unit incorporating, on the one hand, a part at least of an exhaust gas recirculation circuit and a heat exchanger for cooling said gases, preferably of elongated form, together with at least one gas flow regulation/diversion component, and, on the other hand, a part at least of the engine cooling circuit, with at least the water outlet casing and a thermostatic component for regulating the flow therein, and in that said structural assembly comprises a second functional unit in the form of a substantially flat plate-shaped body, forming a stiffening and fixing plate for the first functional unit and a thermal isolation interface between the first functional unit and the engine block, said plate-shaped body comprising on one of its faces sites for fitting and fixing the first functional unit and on the other face sites for fitting and fixing on the engine block.

### BRIEF DESCRIPTION OF THE DRAWINGS

The invention will be better understood with the aid of the description below, which relates to a preferred embodiment, given as a non-limiting example, and explained with reference to the enclosed drawings, in which:

FIGS. 1 and 2 are views in perspective from two different angles of a functional module according to the invention;

FIG. 3 is a view in perspective similar to the one in FIG. 2 showing the first functional unit, the second functional unit having been removed;

FIG. 4 is a view in perspective of the functional module in FIGS. 1 and 2, a part of the water outlet casing having been removed;

FIG. 5 is a view in section along A-A of the module illustrated in FIG. 1;

FIG. 6 is a transparent view in perspective showing the internal elements of the exchanger and the second metallic part of the first functional unit, forming part of the module according to the invention;

FIGS. 7 and 8 are views in perspective of the two faces of the second functional unit forming a plate-shaped body and forming part of the module according to the invention;

FIG. 9 is a view in perspective of a plate-shaped body according to a variant embodiment of the invention showing diagrammatically the production of a conduit portion in this body for circulating the coolant liquid;

FIG. 10 is a view in perspective of a second metallic part forming part of the first functional unit of a module as illustrated in FIGS. 1, 2 and 4;

FIG. 11 is a view in longitudinal section along B-B of the second metallic part illustrated in FIG. 10, and

FIG. 12 is a view in section along C-C of the object of FIG. 11.

### DETAILED DESCRIPTION OF THE INVENTION

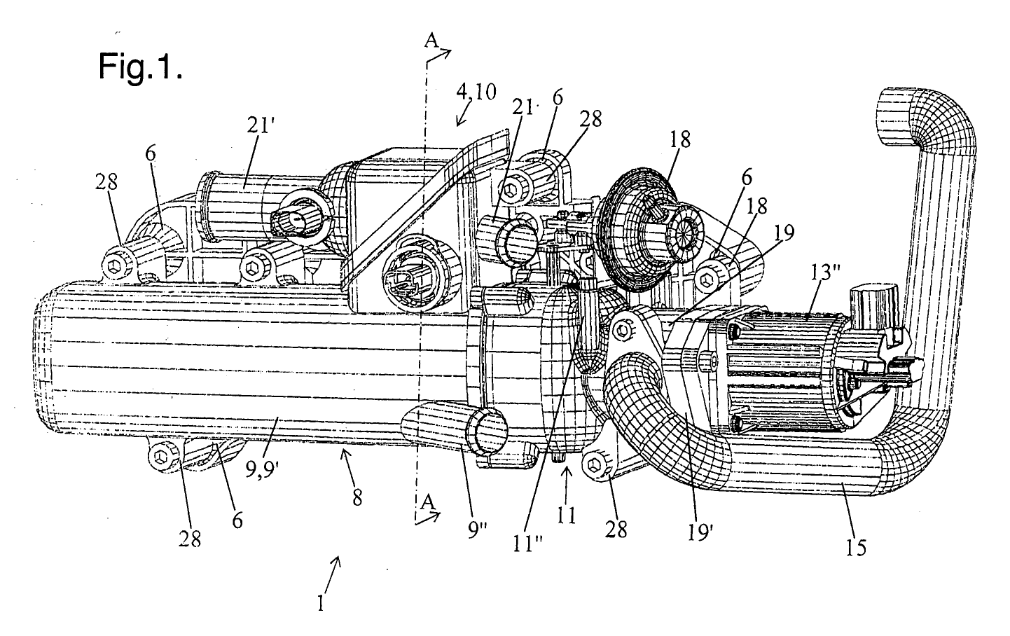

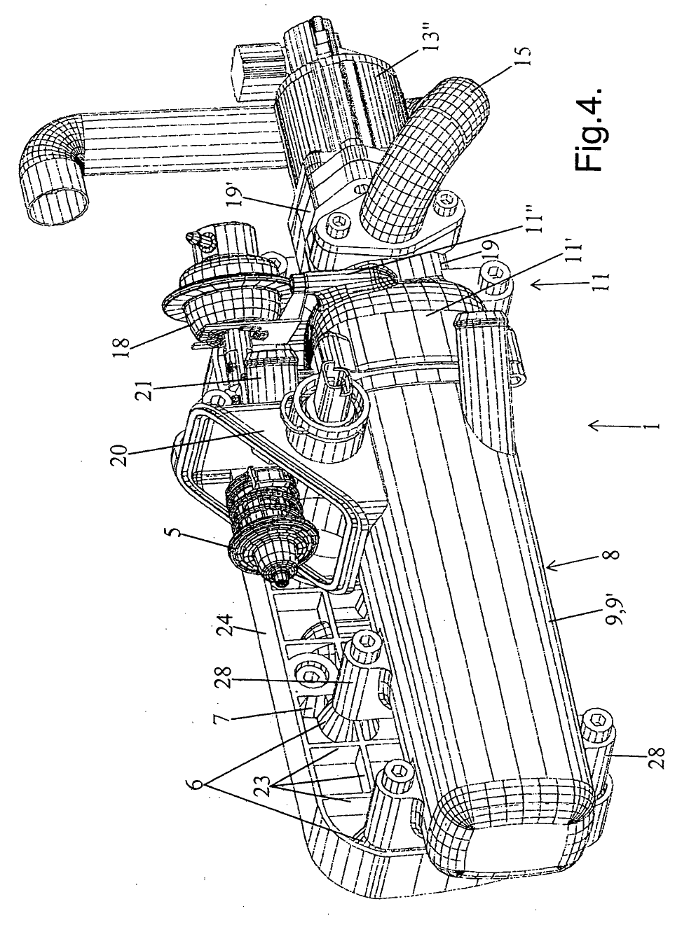

FIGS. 1, 2 and 4 show a multifunctional module 1 for an internal combustion engine, forming a structural assembly and incorporating the functions of exhaust gas cooling and of regulation, at least in part, of the circulation flows in the cooling circuit of said engine.

This module 1 is characterized in that said structural assembly comprises a first functional unit 2 incorporating, on the one hand, a part at least of an exhaust gas recirculation circuit and a heat exchanger for cooling said gases, preferably of elongated form, together with at least one component 13, 13′ for regulating/diverting the gas flow, and, on the other hand, a part at least of the engine cooling circuit, with at least the water outlet casing 4 and a thermostatic component 5 for regulating the flow therein, and in that said structural assembly comprises a second functional unit 3 in the form of a substantially flat plate-shaped body, forming a stiffening and fixing plate for the first functional unit 2 and a thermal isolation interface between the first functional unit and the engine block, said plate-shaped body 3 comprising on one of its faces sites 6 for fitting and fixing the first functional unit and on the other face sites 7 for fitting and fixing on the engine block.

With the aid of the arrangements set out above, a compact multifunctional module 1 is achieved that can be fixed directly on the engine block without being subject to the constraints of a particular location imposed by the fixing and anchoring points of the first functional unit 2, the second functional unit 3 making it possible to mutually offset the fixing sites 6 and 7 respectively present on the two faces of said plate-shaped body forming this unit or body 3. In addition, given the thermal isolation introduced by this body 3, associated possibly with a particular circulation of the coolant liquid, it is possible to produce at least part of the first functional unit 2 in a non-metallic material.

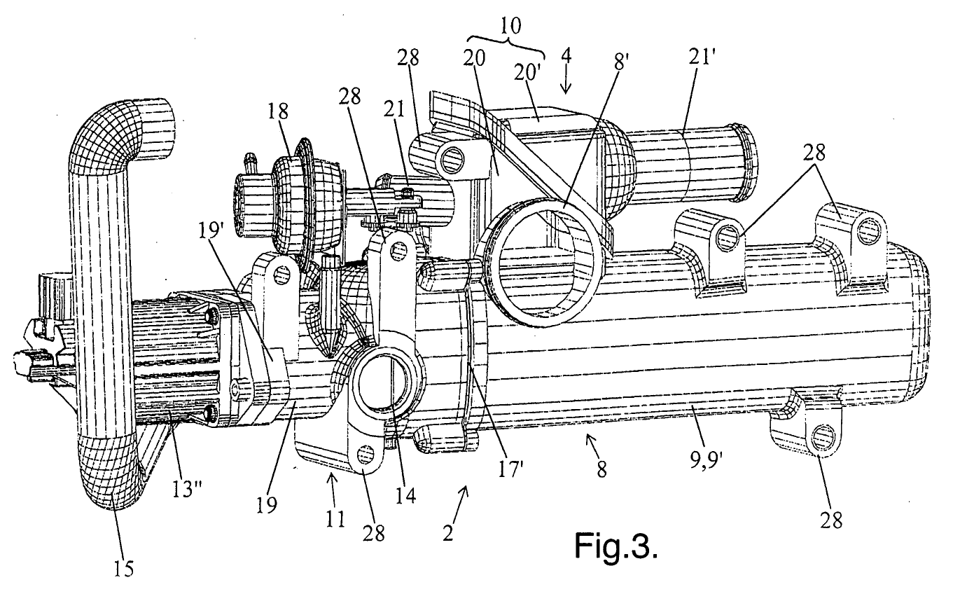

According to a first characteristic of the invention, brought out particularly in FIGS. 1 to 5 of the accompanying drawings, the first unit 2 is substantially composed by assembly, on the one hand, of a first part 8 in plastics material comprising principally a first hollow body 9 forming a part at least of the tank 9′ of the heat exchanger and a second hollow body 10 forming the water outlet casing 10, these two bodies 9 and 10 being adjacent and in fluidic communication, on the other hand, a second part II in a metallic material forming an exhaust gas distribution chamber 12, incorporating at least one gas flow regulation and/or diversion component 13, 13′ and comprising inlet and outlet openings 14, 14′ connected respectively to conduits 15, 15′ forming the circulation circuit of said gases and, finally, a bundle of tubes 16, the majority of which are situated in the first hollow body 9 of the first part 8 and of which the inlet and outlet end portions 16′open into said distribution chamber 12, said bundle of tubes 16 being positioned and mounted in said first hollow body 9 by means of a support body 17 thus forming with it the heat exchanger, said support body 17 also providing a seal in the region of the assembly interface between said first hollow body 9 and the second part 11 in metallic material and closing the tank 9′ of the exchanger.

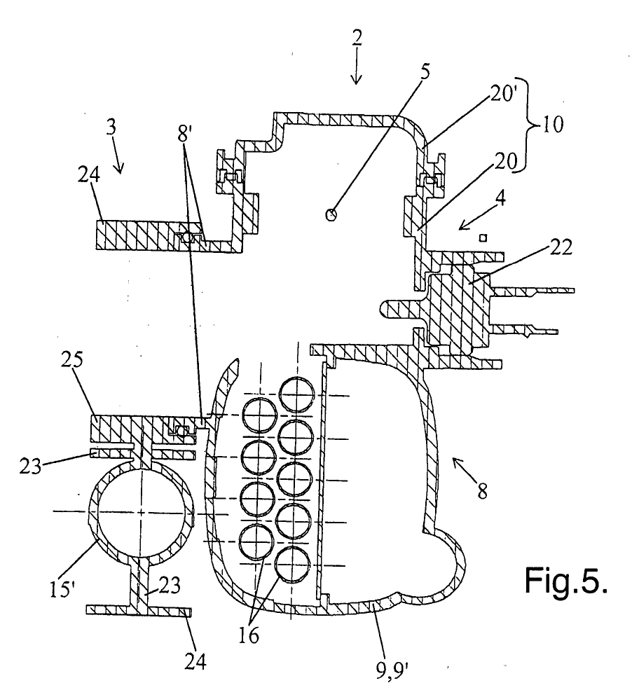

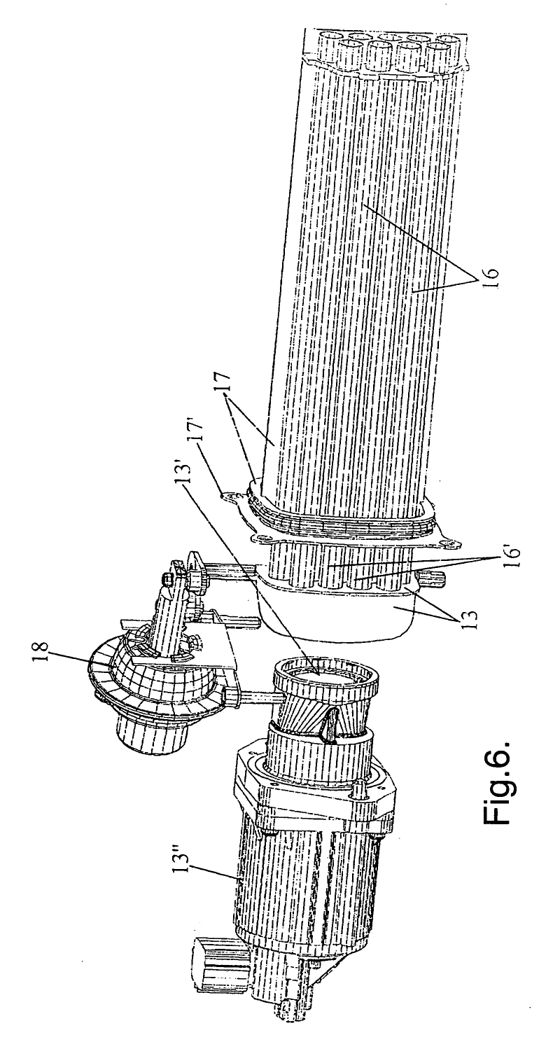

With a view to organising the circulation of gases in the second part 11 and controlling its degree of cooling, the exhaust gas distribution chamber 12 contains a regulation component 13 in the form of a valve controlling the admission of gases in the region of the openings of the inlet end portions 16′ of the tubes 16 of the exchanger, preferably U-shaped, the position of said component 13 being determined by an actuator 18 outside said chamber 12: In addition, said distribution chamber 12 also comprises a regulation component 13, for example in the form of a flap gate or the like, controlling quantitatively the flow of exhaust gases admitted into said chamber 12 by the inlet opening 14 (FIGS. 5 and 6).

The regulation component 13 will thus control the rate of more or less cooled exhaust gas reinjected by means of the conduit 15 into the inlet manifold (not illustrated).

The actuator 18, for example of the electric or hydraulic type, may advantageously be mounted on or at least supported by one of the two units 2 or 3, by means of a support part that is attached or formed in a single piece.

According to a preferred embodiment, and as shown in FIGS. 1 to 3 and 10 of the accompanying drawings, the second part 11 has a generally bell-shaped structure and is assembled with the hollow body 9 forming the elongated tank of the first part 8 in the region of an opening in said body 9 through which pass the inlet and outlet end portions 16′ of the tubes 16 of the exchanger, one part 17′ in the form of a flat frame of the body 17 supporting the bundle of tubes 16 being sandwiched between the assembly edges of the second part 11 and said first hollow body 9 of the first part 8.

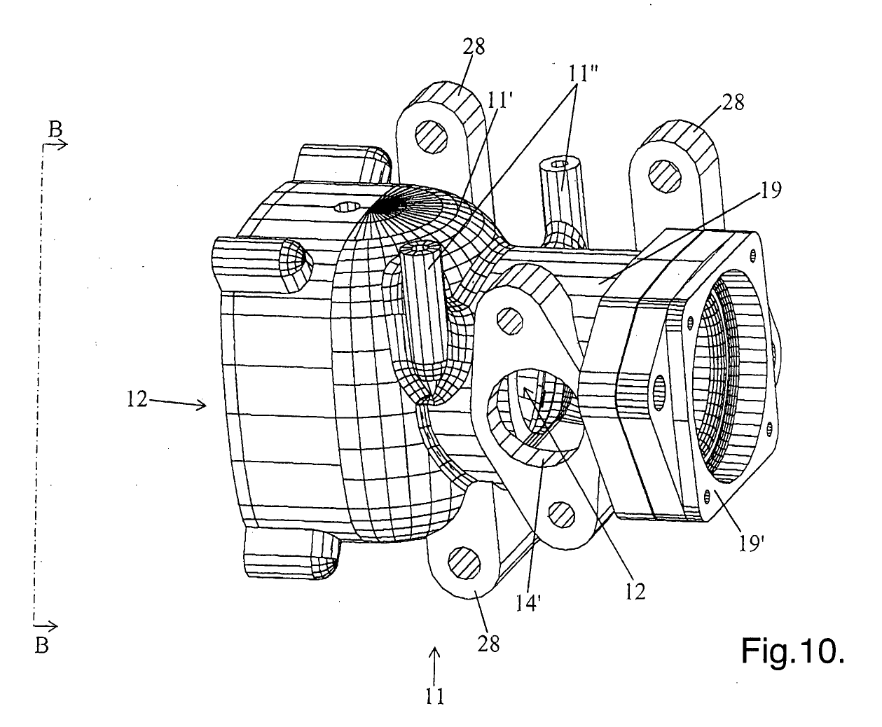

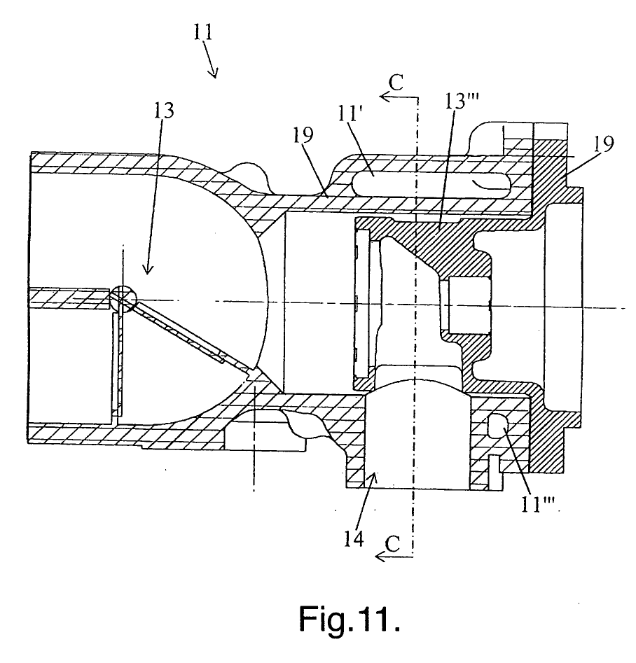

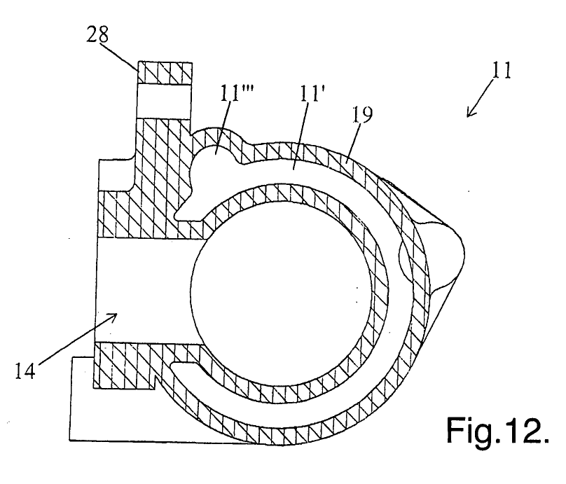

With a view to avoiding too great a rise in temperature due to the exhaust gases from the engine directly admitted into it, provision may advantageously be made for the second metallic bell-shaped part 11 to have, at least in part, a double wall 11 ′ with an intermediary interstice and/or a plurality of canals 11′″ embedded in its thickness and/or attached, delimiting a coolant liquid circulation space, supply and discharge opening(s) or endpiece(s) 11″ for said liquid being formed on or arranged in said second part 11, and for said bell-shaped second part 11 to have a tubular portion 19 in which are arranged exhaust gas inlet 14 and outlet 14′ openings and which comprises an opening with a mounting site 19 for the actuator 13″ of a regulation component 13′ controlling quantitatively the flow of exhaust gases admitted into said chamber 12 through said inlet opening 13′ (FIGS. 10 to 12). The body 13′″ of the component 13′can be seen in FIG. 11.

To facilitate manufacture of the second hollow body 10 and allow the installation of at least one internal regulation component, said second hollow body 10 of the first part 8 forming the envelope of the water outlet casing 4 consists of two parts 20 and 20′ assembled together, for example by vibration welding, a first part 20 being formed in a single piece with the first hollow body 9, while possibly comprising a liquid inlet or outlet endpiece 21, and the second attached part 20′possibly being formed in a single piece with a water outlet endpiece 21′, said water outlet casing 4 also comprising mounting sites for a thermostatic component 5 for regulating the flow of liquid discharged by the water outlet endpiece 21 ′ and a temperature sensor 22 in contact with the interior volume of said water outlet casing 4 (FIGS. 1 to 5).

The first hollow body 9 forming the tank of the exchanger may comprise a liquid outlet endpiece 9″ formed in a single piece, allowing said liquid to be sent towards a fan convector.

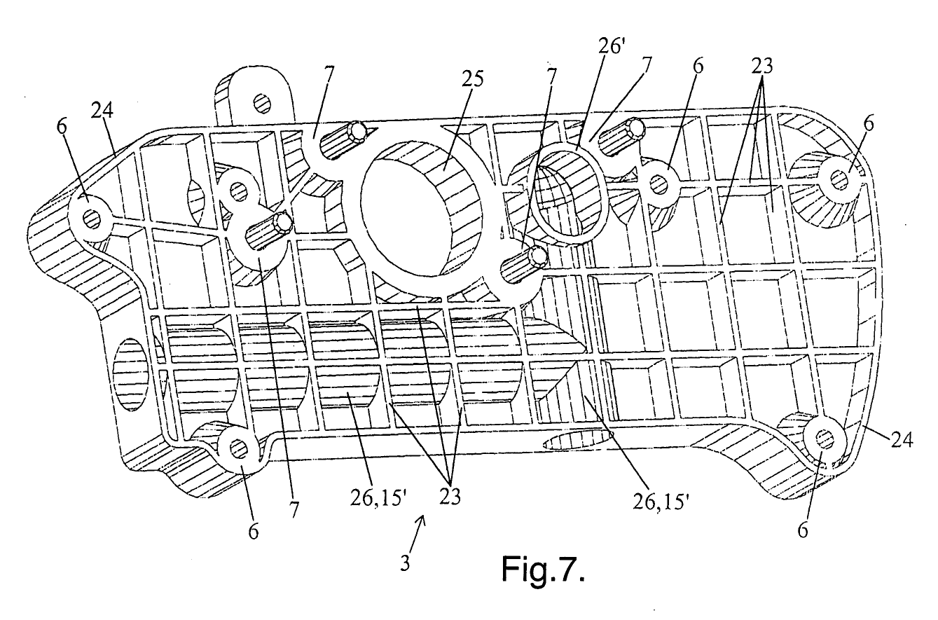

According to a very advantageous characteristic of the invention, the substantially flat, plate-shaped body 3 consists of a metallic material comprising fitting and fixing sites 6 and 7 offset on one face in relation to the other, and has a rigid openwork structure similar to a lattice or grating consisting of a network of ribs in the form of rigid bands of material, preferably flat, interlaced in two dimensions, situated on edge in relation to the plane of the plate-shaped body 3 and delimited by a peripheral frame 24, also formed advantageously by a band of material situated on edge, so as to form a substantially hollow plate of a determined thickness, the fixing and fitting sites 6 and 7 being incorporated into said openwork structure, that structure being formed in a single piece, for example by moulding (FIGS. 7 to 9).

By using such a body 3 of cell-like or open-meshed structure, it is possible to achieve an optimal compromise between a rigid structure, a reduced amount of constituent material, an effective thermal screen and a large useful surface.

Such a meshed rigid structure allows a shaft of isolating air to be created, the sections of thermal bridges to be limited, the ribs to be cooled by allowing the circulation of air in the region of their open parts and a large dissipation surface to be provided.

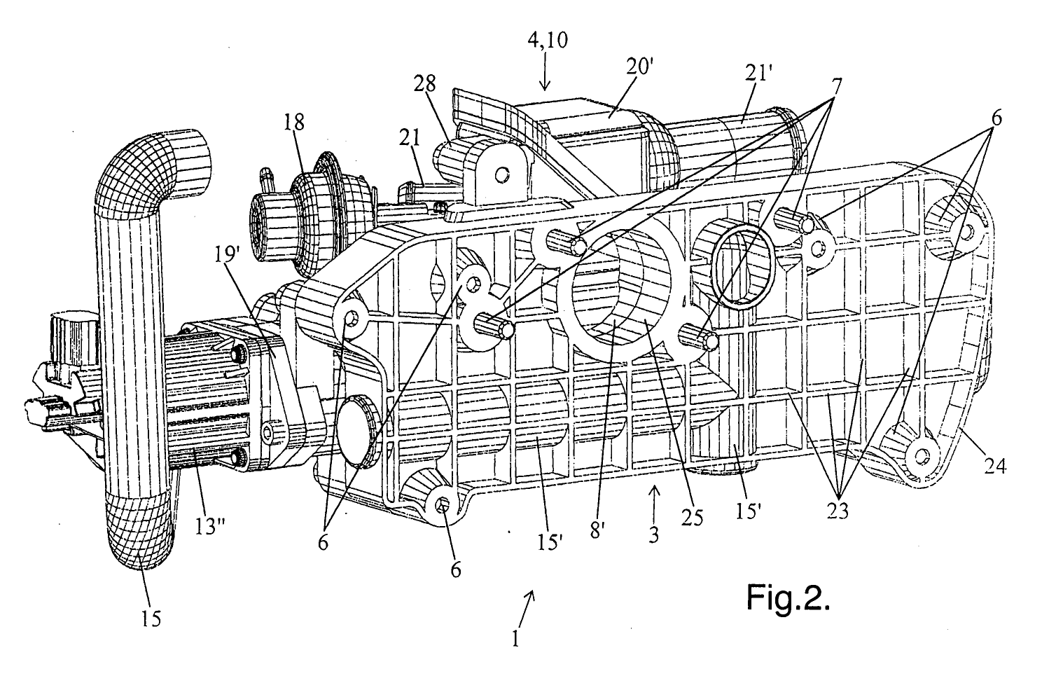

Advantageously, the openwork structure forming the plate-shaped body 3 incorporates at least one portion of tubular conduit 25 extending perpendicularly to the plane of said body 3 and connecting, when module 1 is fitted, the outlet of the engine block's internal coolant liquid circulation circuit to an admission opening or endpiece 8′common to the two hollow bodies 9, 10 forming the first part 8 (FIGS. 2, 3, 5, 7 to 9). It is thus possible to eliminate a separate conduit portion and shorten the length of that portion of the coolant liquid circulation circuit to the maximum.

With a view to reducing still further the number of conduit segments needed to form the coolant liquid circulation and/or exhaust gas recirculation circuits, thus reducing the size of said circuits and taking advantage of the nature and properties of the constituent material and of the structure of the body 3, the flat openwork structure forming the plate-shaped body 3 incorporates at least one portion of conduit or tube 26, 27 extending in the thickness of said structure and connecting at least two openings 26′, 27′ to each other, inlet and outlet respectively, each opening onto one of the two opposite faces of the plate-shaped body 3 or both on the same face thereof (FIGS. 2, 5, 7 to 9).

This or these tube portion(s) 26, 27 will consist advantageously of communicating association of straight conduit segments opening to the exterior in the region of the peripheral frame 24 (sealing the emission holes with plugs), in order to allow the body 3 to be manufactured by moulding.

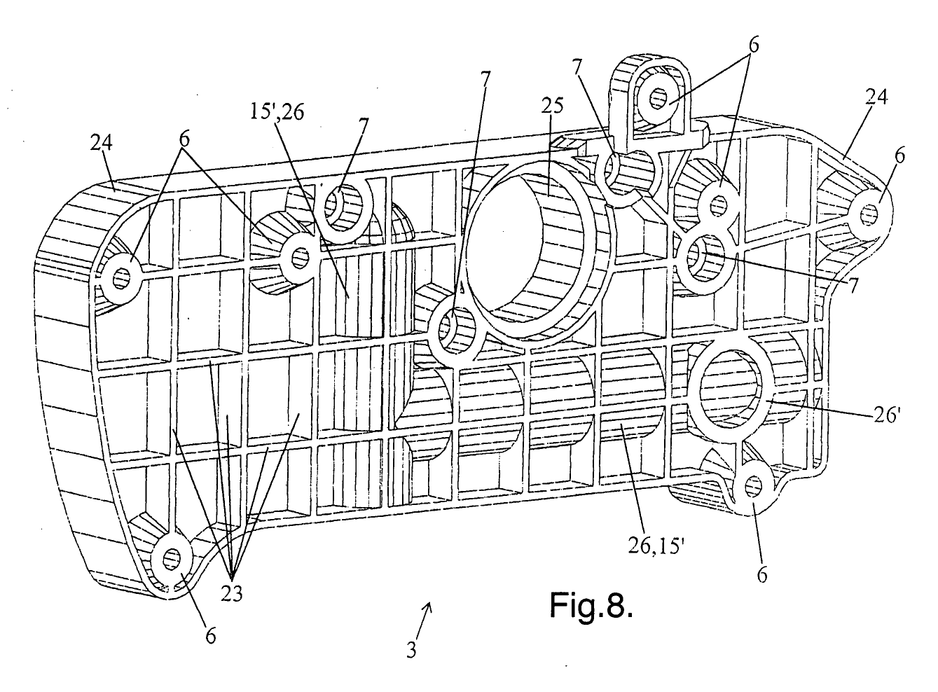

According to a first variant embodiment of the invention, brought out particularly in FIGS. 7 and 8 of the accompanying drawings, the flat openwork structure incorporates at least one portion of conduit or tube 26 forming part of the exhaust gas recirculation circuit and connecting, for example, the engine block's exhaust gas outlet to the gas inlet opening 14 of the distribution chamber 12 of the second part 11.

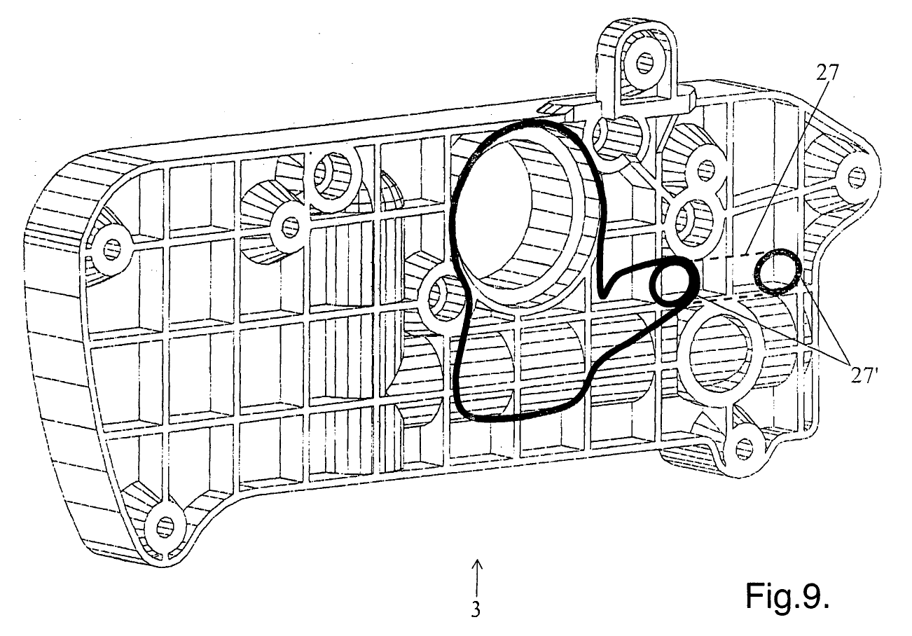

According to a second variant embodiment, brought out in FIG. 9 of the accompanying drawings, the flat openwork structure incorporates at least one portion of conduit or tube 27 forming part of the engine block's coolant circuit, said portion of conduit or tube being preferably connected or in fluidic communication with the tubular conduit portion 25 crossing said structure transversely.

This incorporated conduit portion 27 could possibly serve to supply coolant liquid to the interstice of the double wall 11′ of the part 11 and/or the canals 11″ thereof.

Provision may of course also be made for said body 3 to incorporate at the same time portions of circulation conduit for the coolant liquid 27 and for the exhaust gases 26, separated from each other and each comprising its own openings (not illustrated).

Moreover, provision may also be made for the body 3 to incorporate conduit portions for circulating coolant liquid with a view to cooling said body.

As also shown in the figures of the accompanying drawings, the first and second parts 9 and 11 of the first functional unit 2 comprise fixing sites 28, for example in the form of eyelets or lugs, formed in a single piece for assembly with the corresponding fitting and fixing sites 6 of the second functional unit 3 in the form of a plate-shaped body.

The invention also relates to a motor vehicle comprising an internal combustion engine, characterized in that it comprises a multifunctional module as described above.

Finally, the invention also relates to a process for manufacturing such a module, characterized in that it consists of producing the first part 8, the second part 11 and the plate-shaped body 3 separately, then assembling the first part 8 with the second part 11, for example by means of nut and bolt units and, finally, fitting and fixing, for example by means of screws, the first functional unit 2 thus formed on the plate-shaped body 3.

Of course, the invention is not limited to the embodiments described and illustrated in the accompanying drawings. Modifications are possible, particularly from the point of view of the composition of the various elements or by substitution of technical equivalents, without thereby departing from the scope of protection of the invention.

The present disclosure relates to subject matter contained in French Application No. 0409923, filed on Sep. 20, 2004, the contents of which are herein expressly incorporated by reference in its entirety.

1. Multifunctional module for internal combustion engines, forming a structural assembly and incorporating the functions of exhaust gas cooling and the at least partial regulation of circulation flows in the cooling circuit of said engine, a module characterized in that said structural assembly comprises a first functional unit incorporating, on the one hand, a part at least of an exhaust gas recirculation circuit and a heat exchanger for cooling said gases, preferably of elongated form, together with at least one gas flow regulation/diversion component and, on the other hand, a part at least of the engine cooling circuit, with at least the water outlet casing and a thermostatic component for regulating the flow therein, and in that said structural assembly comprises a second functional unit in the form of a substantially flat plate-shaped body, forming a stiffening and fixing plate for the first functional unit and a thermal isolation interface between the first functional unit and the engine block, said plate-shaped body comprising on one of its faces sites for fitting and fixing the first functional unit and on the other face sites for fitting and fixing on the engine block.

2. Module according to claim 1, characterized in that the first unit is substantially composed by assembly, on the one hand, of a first part in plastics material comprising principally a first hollow body forming a part at least of the tank of the heat exchanger and a second hollow body forming the water outlet casing, these two bodies being adjacent and in fluidic communication, on the other hand, a second part in a metallic material forming an exhaust gas distribution chamber, incorporating at least one gas flow regulation and/or diversion component and comprising inlet and outlet openings connected respectively to conduits forming the circulation circuit of said gases and, finally, a bundle of tubes, the majority of which are situated in the first hollow body 4 of the first part and of which the inlet and outlet end portions open into said distribution chamber, said bundle of tubes being positioned and mounted in said first hollow body by means of a support body thus forming with it the heat exchanger, said support body also providing a seal in the region of the assembly interface between said first hollow body and the second part in metallic material and closing the tank of the exchanger.

3. Module according to claim 2, characterized in that the exhaust gas distribution chamber contains a regulation component in the form of a valve controlling the admission of gases in the region of the openings of the inlet end portions of the tubes of the exchanger, preferably U-shaped, the position of said component being determined by an actuator outside said chamber, and in that said distribution chamber also comprises a regulation component, for example in the form of a flap gate or the like, controlling quantitatively the flow of exhaust gases admitted into said chamber by the inlet opening.

4. Module according to claim 2, characterized in that the second part has a generally bell-shaped structure and is assembled with the hollow body forming the elongated tank of the first part in the region of an opening in said body through which pass the inlet and outlet end portions of the tubes of the exchanger, one part in the form of a flat frame of the body supporting the bundle of tubes being sandwiched between the assembly edges of the second part and said first hollow body of the first part.

5. Module according to claim 4, characterized in that the second metallic bell-shaped part has, at least in part, a double wall with an intermediary interstice and/or a plurality of canals embedded in its thickness and/or attached, delimiting a coolant liquid circulation space, supply and discharge opening(s) or endpiece(s) for said liquid being formed on or arranged in said second part and in that said bell-shaped second part has a tubular potion in which are arranged exhaust gas inlet and outlet openings and which comprises an opening with a mounting site for the actuator of a regulation component controlling quantitatively the flow of exhaust gases admitted into said chamber through said inlet opening.

6. Module according to claim 2, characterized in that the second hollow body of the first part forming the envelope of the water outlet casing consists of two parts assembled together, for example by vibration welding, a first part being formed in a single piece with the first hollow body, while possibly comprising a liquid inlet or outlet endpiece, and the second attached part possibly being formed in a single piece with a water outlet endpiece said water outlet casing also comprising mounting sites for a thermostatic component for regulating the flow of liquid discharged by the water outlet endpiece and a temperature sensor in contact with the interior space of said water outlet casing.

7. Module according to claim 1, characterized in that the substantially flat, plate-shaped body consists of a metallic material comprising fitting and fixing sites offset on one face in relation to the other, and has a rigid openwork structure similar to a lattice or grating consisting of a network of ribs in the form of rigid bands of material, preferably flat, interlaced in two dimensions, situated on edge in relation to the plane of the plate-shaped body and delimited by a peripheral frame, also formed advantageously by a band of material situated on edge, so as to form a substantially hollow plate of a determined thickness, the fixing and fitting sites being incorporated into said openwork structure, that structure being formed in a single piece, for example by moulding.

8. Module according to claim 7, characterized in that the openwork structure forming the plate-shaped body incorporates at least one portion of tubular conduit extending perpendicularly to the plane of said body and connecting, when module is fitted, the outlet of the engine block's internal coolant liquid circulation circuit to an admission opening or endpiece common to the two hollow bodies forming the first part.

9. Module according to claim 7, characterized in that the flat openwork structure forming the plate-shaped body incorporates at least one portion of conduit or tube extending in the thickness of said structure and connecting at least two openings to each other, inlet and outlet respectively, each opening onto one of the two opposite faces of the plate-shaped body or both on the same face thereof.

10. Module according to claim 9, characterized in that the flat openwork structure incorporates at least one portion of conduit or tube forming part of the exhaust gas recirculation circuit and connecting, for example, the engine block's exhaust gas outlet to the gas inlet opening of the distribution chamber of the second part.

11. Module according to claim 9, characterized in that the flat openwork structure incorporates at least one portion of conduit or tube forming part of the engine block's coolant circuit, said portion of conduit or tube being preferably connected or in fluidic communication with the tubular conduit portion crossing said structure transversely.

12. Module according to claim 2, characterized in that the first and second parts of the first functional unit comprise fixing sites, for example in the form of eyelets or lugs, formed in a single piece for assembly with the corresponding fitting and fixing sites of the second functional unit in the form of a plate-shaped body.

13. Motor vehicle comprising an internal combustion engine, characterized in that it comprises a multifunctional module according to claim 1.

14. Process for manufacturing a module according to claim 1, characterized in that it consists of producing the first part, the second part and the plate-shaped body separately, then assembling the first part with the second part, for example by means of nut and bolt units and, finally, fitting and fixing, for example by means of screws, the first functional unit thus formed on the plate-shaped body.
